(19) United States
(12) Patent Application Publication
(10) Pub. No.: US 2010/0060930 A1
(43) Pub. Date: Mar. 11, 2010

(54) PRINTING SYSTEM AND COMPUTER READABLE STORAGE MEDIUM FOR USE THEREIN

(75) Inventor: Norihiko Asai, Tajimi-shi (JP)

Correspondence Address: SCULLY SCOTT MURPHY & PRESSER, PC, 400 GARDEN CITY PLAZA, SUITE 300, GARDEN CITY, NY, 11530, US

(73) Assignee: BROTHER KOGYO KABUSHIKI KAISHA, Aichi-ken (JP)

(21) Appl. No.: 12/556,110

(22) Filed: Sep. 9, 2009

(30) Foreign Application Priority Data
Sep. 11, 2008 (JP) 2008-234073

(51) Int. Cl. G06F 3/12

(52) U.S. Cl. 358/1.15

(57) ABSTRACT

A data processing device includes a storage section, a path retrieving section, a judging section, and a print job creating section. The storage section stores a path for accessing to a predefined storage area. The path retrieving section retrieves a path of a storage area storing print data to be printed. The judging section judges a relationship between the path of a predefined storage area and the path of a storage area. The print job creating section creates a secure print job containing the print data when the judging section makes a prescribed judgment that the path for accessing to a predefined storage area and the path of a storage area are in a prescribed relationship, the secure print job is transmitted to a printer for printing the print data under a restricted circumstance.

### CROSS REFERENCE TO RELATED APPLICATION

This application claims priority from Japanese Patent Application No. 2008-234073 filed Sep. 11, 2008. The entire content of the priority application is incorporated herein by reference.

### TECHNICAL FIELD

The present invention relates to a print job system for creating a print job, and computer readable storage medium used therein.

### BACKGROUND

Network printers have been extensively used for allowing plural computers on a network to share the printers. Some materials to be printed by such a computer may be confidential and others may not. In order to preserve the confidentiality and prevent information leakage, each computer on the network needs to be so configured that confidential information cannot be accessed and printed by an unauthorized person.

### SUMMARY

In view of the foregoing, it is an object of the invention to provide a new print job style that does not allow an unauthorized person to print confidential information.

In order to attain the above and other object, the invention provides a data processing device. The data processing device includes a storage section, a path retrieving section, a judging section, and a print job creating section. The storage section stores a path for accessing to a predefined storage area. The path retrieving section is configured to retrieve a path of a storage area storing print data to be printed. The judging section is configured to judge a relationship between the path for accessing to a predefined storage area and the path of a storage area retrieved by the path retrieving section. The print job creating section is configured to create a secure print job containing the print data when the judging section makes a judgment that the path for accessing to the predefined storage area and the path of the storage area are in a prescribed relationship. The secure print job is transmitted to a printer for printing the print data under a restricted circumstance.

According to another aspect, the present invention provides a printing system. The printing system includes a data processing device and a printer. The printer is communicably connected to the data processing device. The data processing device includes a storage section, a path retrieving section, a judging section, a print job creating section, and a transmission section. The storage section stores a path for accessing to a predefined storage area. The path retrieving section is configured to retrieve a path of a storage area storing print data to be printed. The judging section is configured to judge a relationship between the path for accessing to the predefined storage area and the path of the storage area retrieved by the path retrieving section. The print job creating section is configured to create a secure print job containing the print data and information about authentication of an authorized user when the judging section makes a judgment that the path for accessing to the predefined storage area and the path of the storage area are in a prescribed relationship. The transmission section is configured to transmit the secure print job. The printer includes a receiving section, a printing section, a print mode setting section, and an authentication section. The receiving section is configured to receive the secure print job transmitted from the transmission section. The print mode setting section is configured to selectively set the printing section to operate under either one of a secure print mode and a normal print mode. The authentication section is configured to perform authentication of the information about an authorized user included in the secure print job. The printing section executes printing of the secure print job when the secure print mode is set and the authentication proves to be the authorized user.

According to still another aspect, the present invention provides a computer-readable storage medium storing a set of program instructions installed on and executed by a computer for controlling a data processing device. The program instructions includes storing a path for accessing to a predefined storage area, retrieving a path of a storage area storing print data to be printed, judging a relationship between the path for accessing to the predefined storage area and the path of the storage area being retrieved, creating a secure print job containing the print data when a judgment is made so that the path for accessing to the predefined storage area and the path of the storage area are in a prescribed relationship, and transmitting the secure print job to a printer for printing the print data under a restricted circumstance.

According still another aspect, the present invention provides a method of creating a print job to be transmitted to a printer. The method includes storing a path for accessing to a predefined storage area, retrieving a path of a storage area storing print data to be printed, judging a relationship between the path for accessing to the predefined storage area and the path of the storage area being retrieved, and creating a secure print job containing the print data when a judgment is made so that the path for accessing to the predefined storage area and the path of the storage area are in a prescribed relationship, the secure print job being transmitted to the printer for printing the print data under a restricted circumstance.

### BRIEF DESCRIPTION OF THE DRAWINGS

In the drawings,

FIG. 1 is a block diagram showing a printing system according to an embodiment of the present invention;

FIG. 2 is a secure setting dialogue screen used in the embodiment of the preset invention;

FIG. 3 is a flowchart illustrating a print job creating process on a personal computer;

FIG. 4(a) is an explanatory diagram of the print job when a secure flag is set to “0”;

FIG. 4(b) is an explanatory diagram of the print job when the secure flag is set to “1”; and

FIG. 5 is a flowchart illustrating a secure print process on a printer.

### DETAILED DESCRIPTION

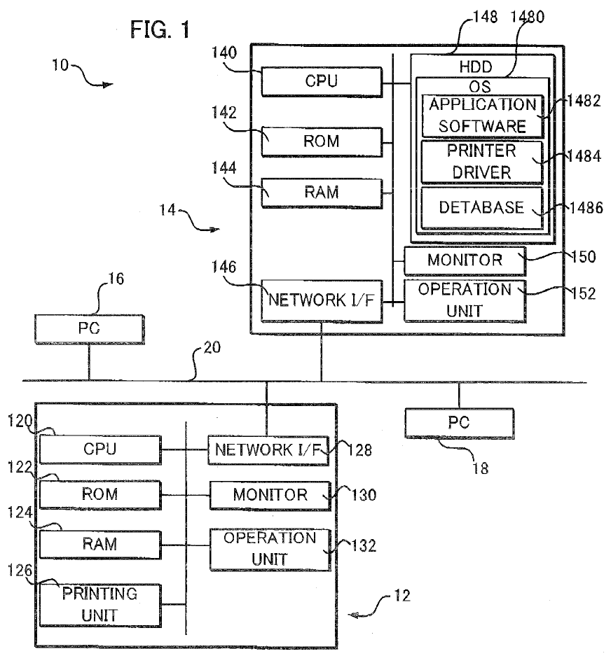

A printing system according to one embodiment of the present invention will be described with reference to FIGS. 1 to 5. In the following description, the term “secure print” will be used to mean printing to be performed under a secure management for minimizing a risk of leakage of confidential information contained in data to be printed. Also, the term “secure setting” will be used to mean settings to the secure print.

As shown in FIG. 1, a printing system 10 includes a printer 12 and a plurality of personal computers 14, 16, and 18 (hereinafter referred to as PC) which are communicably connected to one another by a LAN 20 (Local Area Network). The printer 12 receives a print job sent from one of the PCs and performs a print process.

The printer 12 is provided with a CPU 120, a ROM 122, a RAM 124, a printing unit 126, a network interface 128 (hereinafter referred to as network I/F), a monitor 130, and an operation unit 132.

The CPU 120 governs the components contained in the print device 12. Various programs executed by the CPU 120 are stored in the ROM 122. The RAM 124 temporarily stores various data and is accessed by the CPU 120 when the CPU 120 executes the program stored in the ROM 122. The various processes are executed by the programs stored in the ROM 122. A plurality of print jobs are stored in the RAM 124 for the secure print. The printing unit 126 attends to printing of the print job. The network I/F 128 is connected to the LAN 20. The monitor 130 displays various information. The operation unit 132 functions as an input interface for the print device 12 and includes a secure button for allowing a user to select a secure print mode.

The PC 14 is provided with a CPU 140, a ROM 142, a RAM 144, a network I/F 146 connected to the LAN 20, a hard-disk 148 (hereinafter referred to as HDD), a monitor 150, and an operation unit 152 such as a keyboard or a mouse. The HDD 148 stores an OS (Operating System) 1480, an application software 1482 such as a word processing software, a printer driver 1484 used for the printer 12, and a database 1486 for managing set data of the OS 1480, application software 1482 and the printer driver 484, e.g., a registry supplied by the OS.

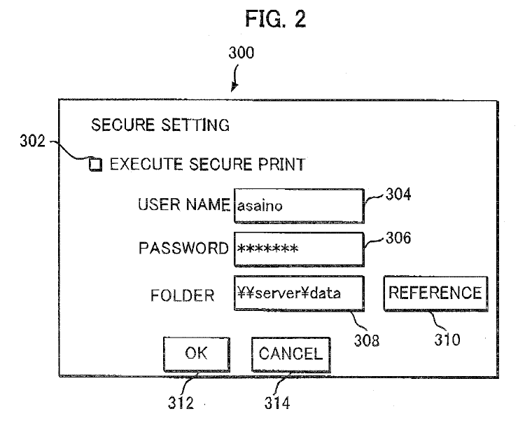

Each process is executed by performing each program stored in the ROM 142 or HDD 148. To this end, the program is read from the ROM 142 or HDD 148 and placed in the RAM 144. The OS 1480, for example, functions to store setting data (see FIG. 2) of the secure print in the database 1486. A print file is created by executing the application software 1482. The print job is created by executing the printer driver 1484. The detailed configuration of the PC 14 will not be described herein because the PC 14 is the same as the well-known personal computer except for the capability of executing the following processes. The same is true with respect to the PCs 16 and 18.

As shown in FIG. 2, a setting window 300 is displayed on the monitor 150 when the instruction for setting the printer driver 1484 into a setting mode is inputted via the operation unit 152 on the PC 14. The setting window 300 is a part of a setting interface of the printer driver 1484. FIG. 2 only shows the items with respect to a secure setting which is to set the secure print.

The setting window 300 includes a check box 302, a user name box 304, a password box 306, a folder box 309, a reference button 310, an OK button 312, and a cancel button 314. The check box 302 is for designating whether or not to perform the secure print. When the CPU 140 detects the check in the check box 302, the CPU 140 stores contents entered into each box in the database 1486.

The user name box is for inputting user names and a password box 306 is for inputting passwords. The inputted user name and the password are used to determine that the user is authorized to perform the secure print of the designated print job. This determination is made on the printer before the start of printing.

The folder box 308 is for inputting the path to a secure folder in which the target file subject to the secure print is stored. In other word, if the print instruction is entered via the operation unit 152 with respect to the file stored in the secure folder or the file stored in the folder in lower hierarchical level than the secure folder, the CPU 140 acquires the print instruction and executes the secure print according to the print instruction.

The reference button 310 is for helping the user in inputting the folder path into the folder box. The CPU 140 controls the monitor 150 to display the folders which are linked hierarchically to be (e.g., the storage area on the LAN 30 or HDD 148) a tree-form upon pushing the reference button 310. When the prescribed folder displayed on the monitor 150 is selected via the operation unit 152, the CPU 140 acquires the path of the selected folder and displays the acquired path on the folder box 308.

The OK 312 button is used for finalizing the settings on the setting window 300. The CPU 140 registers the data inputted into the setting window 300 in the database 1486 upon pushing the OK button 312. When the OK button 312 is pushed while a check is inputted into the check box 302, the data indicating a secure print mode is stored in the database 1486.

The cancel button 314 is used for canceling the settings on the setting window 300 and finishing the secure setting. The CPU 140 finishes the secure setting process without registering the data in the database 1486 when the cancel button 314 is pushed. The above-mentioned data for the secure print may be stored in a specified file.

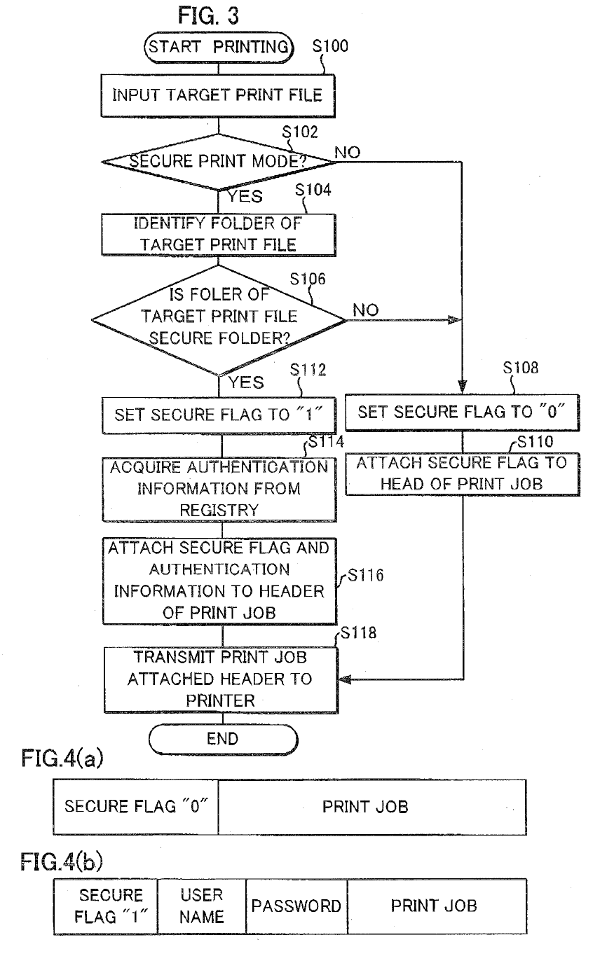

The CPU 140 executes a print job creating process by using the setting data inputted through the setting window 300 and stored in the database 1486. As shown in FIG. 3, a target print file or a target print file name is inputted via the operation unit 152 instructing to print the target print file (S100). The CPU 140 acquires the print instruction and determines whether or not the secure print mode is set (S102). Specifically, the CPU 140 determines whether or not the data indicating the secure setting mode is stored in the database 1486.

If the CPU 140 determines that the data indicating secure print mode is not stored in the database 1486 (S102:NO), the routine advances to S108, whereas if the CPU 140 determines that the data indicating secure print mode is stored in the database 1486 (S102:YES), the CPU 140 identifies the folder of the target print file which is to be printed (S104). The CPU 140 acquires the path lead to the target print file using a predetermined function applied by the OS 1480.

In S106, the CPU 140 determines whether or not the folder storing the target print file is the secure folder. Specifically, the CPU 140 determines the relationship between the path acquired in S104 and the path of the secure folder stored in the database 1486 (S106). If the path of the folder storing the target print file includes the path of the secure folder, i.e., the target print file is stored in the secure folder or the folder which is lower hierarchical level than the secure folder, the CPU 140 determines YES in S106, whereas the path of the folder storing the target print file does not include the secure folder, the CPU 140 determines NO in S106.

If the CPU 140 determines NO in S106, the CPU 140 sets a secure flag into “0” (S108) and attaches the secure flag set in S108 to a header of the print job. If the CPU 140 determines YES in S106, the CPU 140 sets the secure flag into “1” (S112), and the CPU 140 acquires the authentication information such as the user name, the password from the registry (S114). Subsequently, the CPU 140 attaches the secure flag set in S112 and the authentication information obtained in S114 to the header of the print job (S116).

FIG. 4(a) shows the print job created in S110 (hereinafter referred to as print job (a)), and FIG. 4(b) shows the print job created in S116 (hereinafter referred to as print job (b)). The print job (a) includes print data, the print job itself including a setting of the print, for example a paper size and data designating a monochromatic print or a color print, and the secure flag set to “0” in S108 and indicating a normal print. In the normal print, the printing process starts in data receiving order without performing the authentication in the printer 12. The secure flag is described in the header of the print job (a).

The print job (b) includes a print data, the print job itself which is the same construction as the print job (a), the secure flag set to “1”, and the authentication information including the user name and the password. Similarly to the print job (b), the secure flag and the authentication information are described in the header of the print job (b).

In S118, the CPU 140 transmits the print job (a) or (b) toward the printer 12. The CPU 140 controls the network I/F 146 and transfers an address of the printer 12 to the LAN 30, thereby transferring the print job (a) or (b).

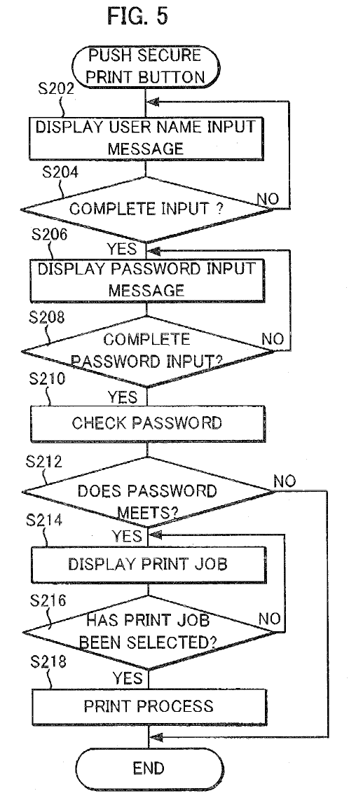

The CPU 120 of the printer 12 executes the secure print process by performing the program stored in the ROM 122 as shown in FIG. 5. Before executing the secure print process in printer 12, the print job (b) is transmitted to the printer 12 (see S118 in FIG. 3) and the CPU 120 receives the print job (b) by controlling the network I/F 128, and at least one of the received print job (b) is stored in the RAM 124.

When the CPU 120 receives the print job (a) via the network I/F 128, the print job (a) is printed in the printing unit 126 without performing the secure print process described below. That is, the CPU 120 determines according to the value of the secure flag included in the header whether the received print job is the print job (a) or the print job (b). If the CPU 120 determines that the print job is the print job (a), the print process is executed (the same process as S218 in FIG. 5) without executing the process shown in FIG. 5, whereas if the CPU 120 determines that the print job is the print job (b), the process shown in FIG. 5 is executed in the printer 12.

When a user who has already transmitted the print job (b) pushes the secure print button provided on the operating unit 132, the CPU 120 sets the printer 12 into the secure print mode and acquires a secure print start instruction. The CPU 120 starts the process as shown in FIG. 5. The CPU 120 controls the monitor 130 to display a user name input message so as to prompt the user to input the user name (S202). Then, the CPU 120 waits until the completion of this input (S204:NO, S202). As to the input of the user name, the CPU 120 retrieves the user name described in the header of the print job (b) and displays the user name in a selectable list-form. The user can select the user name on the list by the operating unit 132 or input the user name directly by a numeric keyboard which is included in the operation unit 132 and can input the alpha-numerals.

When the input of the user name is completed and the CPU 120 acquires the data indicating the selected user name (S204:YES), the CPU 120 controls the monitor 130 to display a password input message so as to prompt the user to input the password (S206). Then the CPU 120 waits until the completion of this input (S208:NO, S206). The input of the password is executed via the numeric keyboard.

The password input operation is fixed via the operation unit 132 and the CPU 120 acquires the inputted password (S208:YES). The CPU 120 determines whether or not the password inputted in S208 meets the password described in the header of the print job (b) including the user name inputted in S204 (S210). If the password does not meet with each other (S212:NO), the process is ended while displaying a relevant message. With this configuration, the print job (b) stored in the RAM 124 is not printed.

If the password inputted in S208 meets the password described in the header of the print job (b) (S212:YES), the CPU 120 retrieves the print job (b) which is determined YES in S212 and controls to display all of the retrieved print jobs (b) in the list-form on the monitor 130 (S214). Specifically, the CPU 120 retrieves the print job (b) accumulated in the RAM 124, when the password and user name are matched. In the list displayed on the monitor 130, the target file name and user name may be related with each other, or a job name and the user name may be related with each other. The CPU 120 waits until the selection of one of the printer jobs (b) (S216:NO, S214). When one of the print jobs (b) is selected (S216:YES), the CPU 120 executes the print process with respect to the selected print job (b) (S218) in the printing unit 126, and ends the process.

In the embodiment, the CPU 140 of the PC 14 determines whether or not the print job transmitted to the printer 12 belongs to the objective of the secure print according to the relationship between the path of the secure folder stored as the secure setting in the database 1486 and the path of the folder storing the target print file (S106 in FIG. 3). If the CPU 140 determines that the target print file belongs to the objective of the secure print (S106:YES), the secure flag (set to “1”) indicating the objective of the secure print is automatically attached to the header of the print job (S112). With this configuration, the user can execute the secure print without the determination whether or not to execute the secure print on a printing basis. When the secure print and the normal print are executed together, the operation burden of the user can be reduced.

In this embodiment, the secure folder designated in the folder box 308 and the file lower hierarchical level than the secure folder are determined to the objective of the secure print in S106. With this configuration, since the path of all folders storing the respective target print files to be printed as the secure print need not to store in the RAM 144, the storing area of the RAM 144 is used efficiently.

While the invention has been described in detail with reference to specific embodiment thereof, if would be apparent to those skilled in the art that many modifications and variations may be made therein without departing from the spirit of the invention, the scope of which is defined by the attached claims.

In the embodiment, the user needs to input the user name and password into the user name box 304 and the password box 306, respectively. However, present invention is not limited to this configuration. For example, if the OS 1480 is configured to prompt inputting the user name and the password to authorize the start-up of the PC 14, the user name and the password for activating the OS 1480 are stored in the database 1486. When the setting window 300 is displayed on the monitor 150, the CPU 140 can display the user name and the password for activating the OS 1480 on the user name box 304 and the password box 306 at the setting window 300 by acquiring the user name and the password from the database 1486, thereby reducing the burden on the user for inputting the user name and the password.

Further in the embodiment, the secure folder designated in the folder box 308 and the file lower hierarchical level than the secure folder are determined to the objective of the secure print in S106. However, the present invention is not limited to this configuration. For example, the secure folder designated in the folder box 308 may be determined to be the objective of the secure print. The determination in S106 is performed based on whether or not the path of the folder storing the target print file meets the path of the secure folder.

Further in the embodiment, the secure folder path lead to the file which is the objective of the secure print is inputted in the folder box 308. However, the present invention is not limited to this configuration. For example, a folder path lead to a file which is not the objective of the secure print may be inputted in the folder box 308 (hereinafter referred to non-secure folder) and stored in the database 1486. If the path of the folder lead to the target print file includes the path of the non-secure folder, i.e., the target print file is stored in the non-secure folder or the folder lower hierarchical level than the non-secure folder, the CPU 140 may determine NO in S106, whereas if the path of the folder storing the target print file does not include the path of the non-secure folder, the CPU 140 may determine YES in S106.

Further in this embodiment, if the password does not meet with each other (S212:NO), the process as shown in FIG. 5 is ended. However, the present invention is not limited to this configuration. For example, if the password does not meet with each other, the message prompting the user to input the password may be displayed on the monitor 130 again and the routine may return to S206. The construction in which the password can input repeatedly is preferably employed in a situation that the password is inputted erroneously. In this situation, since the process shown in FIG. 5 does not need to execute from the beginning, it is possible to reduce the burden on the user to print the secure print. The input of the password a plurality of times, for example three times, can be acceptable (if the determination in S212 is NO, the routine returns to S206), whereas the negative determination in S212 is repeated at three times consecutively (S212:NO), the process may be ended. With this configuration, both ensuring the security and reducing the burden of the user can be achieved.

Further in the embodiment, the CPU 140 executes the print job creating process as shown in FIG. 3 using the printer driver 1484. However, the program configured of the print function in the application software 1482 may execute the print job creating process.

What is claimed is:

1. A data processing device comprising:
a storage section that stores a path for accessing to a predefined storage area;
a path retrieving section that is configured to retrieve a path of a storage area storing print data to be printed;
a judging section that is configured to judge a relationship between the path for accessing to a predefined storage area and the path of a storage area retrieved by the path retrieving section; and
a print job creating section that is configured to create a secure print job containing the print data when the judging section makes a judgment that the path for accessing to the predefined storage area and the path of the storage area are in a prescribed relationship, the secure print job being transmitted to a printer for printing the print data under a restricted circumstance.

2. The data processing device according to claim 1, wherein the print job creating section is configured to create the secure print job to include information about authentication of an authorized user.

3. The data processing device according to claim 1, wherein the print job creating section is further configured to create a normal print job containing the print data when the judging section makes a judgment that the path for accessing to the predefined storage area and the path of the storage area are out of the prescribed relationship, the normal print job being transmitted to the printer for printing the print data under a non-restricted circumstance.

4. The data processing device according to claim 1, wherein the judging section makes a judgment that the path for accessing to the predefined storage area and the path of the storage area are in a prescribed relationship when the path for accessing to the storage area is lower hierarchical level than the path of the predefined storage area.

5. A printing system comprising:
a data processing device; and
a printer communicably connected to the data processing device,
wherein the data processing device comprises:
a storage section that stores a path for accessing to a predefined storage area;
a path retrieving section that is configured to retrieve a path of a storage area storing print data to be printed;
a judging section that is configured to judge a relationship between the path for accessing to the predefined storage area and the path of the storage area retrieved by the path retrieving section;
a print job creating section that is configured to create a secure print job containing the print data and information about authentication of an authorized user when the judging section makes a judgment that the path for accessing to the predefined storage area and the path of the storage area are in a prescribed relationship; and
a transmission section that is configure to transmit the secure print job,
wherein the printer comprises:
a receiving section that is configured to receive the secure print job transmitted from the transmission section;
a printing section;
a print mode setting section that is configured to selectively set the printing section to operate under either one of a secure print mode and a normal print mode;
an authentication section that is configured to perform authentication of the information about an authorized user included in the secure print job, wherein the printing section executes printing of the secure print job when the secure print mode is set and the authentication proves to be the authorized user.

6. The printing system according to claim 5, wherein the print job creating section is further configured to create a normal print job containing the print data when the judging section makes a judgment that the path for accessing to the predefined storage area and the path of the storage area are out of the prescribed relationship, the normal print job being transmitted to the printer for printing the print data under a non-restricted circumstance.

7. The printing system according to claim 5, wherein the judging section makes a judgment that the path for accessing to the predefined storage area and the path of the storage area are in a prescribed relationship when the path for accessing to the storage area is lower hierarchical level than the path of the predefined storage area.

8. A computer-readable storage medium storing a set of program instructions installed on and executed by a computer for controlling a data processing device, the program instructions comprising:
storing a path for accessing to a predefined storage area;
retrieving a path of a storage area storing print data to be printed;
judging a relationship between the path for accessing to the predefined storage area and the path of the storage area being retrieved;
creating a secure print job containing the print data when a judgment is made so that the path for accessing to the predefined storage area and the path of the storage area are in a prescribed relationship; and
transmitting the secure print job to a printer for printing the print data under a restricted circumstance.

9. The computer-readable storage medium according to claim 8, wherein the creation creates the secure print job to include information about authentication of an authorized user.

10. The computer-readable storage medium according to claim 8, wherein the creation further creates a normal print job containing the print data when the judgment that the path for accessing to the predefined storage area and the path of the storage area are out of the prescribed relationship is made, the normal print job being transmitted to the printer for printing the print data under a non-restricted circumstance.

11. The computer-readable storage medium according to claim 8, wherein the judgment that the path for accessing to the predefined storage area and the path of the storage area are in a prescribed relationship is made when the path for accessing to the storage area is lower hierarchical level than the path of the predefined storage area.

12. A method of creating a print job to be transmitted to a printer, the method comprising:
storing a path for accessing to a predefined storage area;
retrieving a path of a storage area storing print data to be printed;
judging a relationship between the path for accessing to the predefined storage area and the path of the storage area being retrieved; and
creating a secure print job containing the print data when a judgment is made so that the path for accessing to the predefined storage area and the path of the storage area are in a prescribed relationship, the secure print job being transmitted to the printer for printing the print data under a restricted circumstance.

13. The data processing device according to claim 12, wherein the creation creates the secure print job to include information about authentication of an authorized user.

14. The data processing device according to claim 12, wherein the creation of the print job further creates a normal print job containing the print data when the judgment that the path for accessing to the predefined storage area and the path of the storage area are out of the prescribed relationship is made, the normal print job being transmitted to the printer for printing the print data under a non-restricted circumstance.

15. The data processing device according to claim 12, wherein the judgment that the path for accessing to the predefined storage area and the path of the storage area are in a prescribed relationship is made when the path for accessing to the storage area is lower hierarchical level than the path of the predefined storage area.
